(19) United States
(12) Patent Application Publication
(10) Pub. No.: US 2013/0262507 A1
(43) Pub. Date: Oct. 3, 2013

(54) METHOD AND SYSTEM TO PROVIDE INLINE SAVED SEARCHES

(71) Applicants: Bhanu Koppaka, San Jose, CA (US); Jai Dandekar, San Jose, CA (US); Govind Kaushal, San Jose, CA (US); Matthew Bret MacLaurin, Santa Cruz, CA (US); Naren Chittar, San Jose, CA (US); John Sheeley, San Francisco, CA (US)

(72) Inventors: Bhanu Koppaka, San Jose, CA (US); Jai Dandekar, San Jose, CA (US); Govind Kaushal, San Jose, CA (US); Matthew Bret MacLaurin, Santa Cruz, CA (US); Naren Chittar, San Jose, CA (US); John Sheeley, San Francisco, CA (US)

(73) Assignee: eBay Inc., San Jose, CA (US)

(21) Appl. No.: 13/725,764

(22) Filed: Dec. 21, 2012

Related U.S. Application Data
(60) Provisional application No. 61/618,120, filed on Mar. 30, 2012.

(51) Int. Cl. G06F 17/30

(52) U.S. Cl. CPC G06F 17/30477
USPC 707/769

(57) ABSTRACT

Method and system to provide inline saved searches are described. In one example embodiment, inline saved search provides on-click access to saving, editing, and retrieval of saved searches. A notification of new item listings in any subsequently performed searches may also be built in.

### TECHNICAL FIELD

This application relates to a method and system to provide Inline saved searches.

### BACKGROUND

An on-line trading platform allows users to shop for almost anything using a web browser application. A user may find an item listed by an on-line trading application by entering keywords into the search box provided on an associated web page or by browsing through the list of categories on the home page. After a list of search results is returned, a user may further refine a search using a list of filters provided in the right-side portion of the search results web page. A user may select an item from the search results to view the details of the item. A user may then return to the search results page to further refine the search by using filters provided in the right-side portion of the search results web page.

### BRIEF DESCRIPTION OF DRAWINGS

Embodiments of the present invention are illustrated by way of example and not limitation in the figures of the accompanying drawings, in which like reference numbers indicate similar elements and in which:

FIG. 1 is a network diagram depicting a client-server system, within which one (c)sample embodiment, may be deployed:

FIG. 2 is a block diagram of a system to provide inline saved searches of search results, in accordance with one example embodiment;

FIG. 3 is a flow chart of a method to provide inline saved searches of search, results, in accordance with an example embodiment;

FIG. 4 shows a user interface including a. hover window that notifies a user that the requested search parameters have been saved, and permits a to request to receive a notification when new items that satisfy the search parameters become available, in accordance with an example embodiment;

FIG. 5 shows a user interface including a hover window that notifies a user that the saved search has been executed that that there are 0 (zero) new listings that satisfy the saved search parameters, as compared to the previously execution of the saved search, in accordance with an example embodiment; and

FIG. 6 is a diagrammatic representation of an example machine in the form of a computer system within which a set of instructions, for causing the machine to perform any one or more of the methodologies discussed herein, may be. executed.

### DETAILED DESCRIPTION

A method and to provide inline saved searches is described. In the following description, for purposes of explanation, numerous specific details are set forth in order to provide a thorough understanding of an embodiment of the present invention. It will be evident, however, to one skilled in the art that the present invention may be practiced without these specific details.

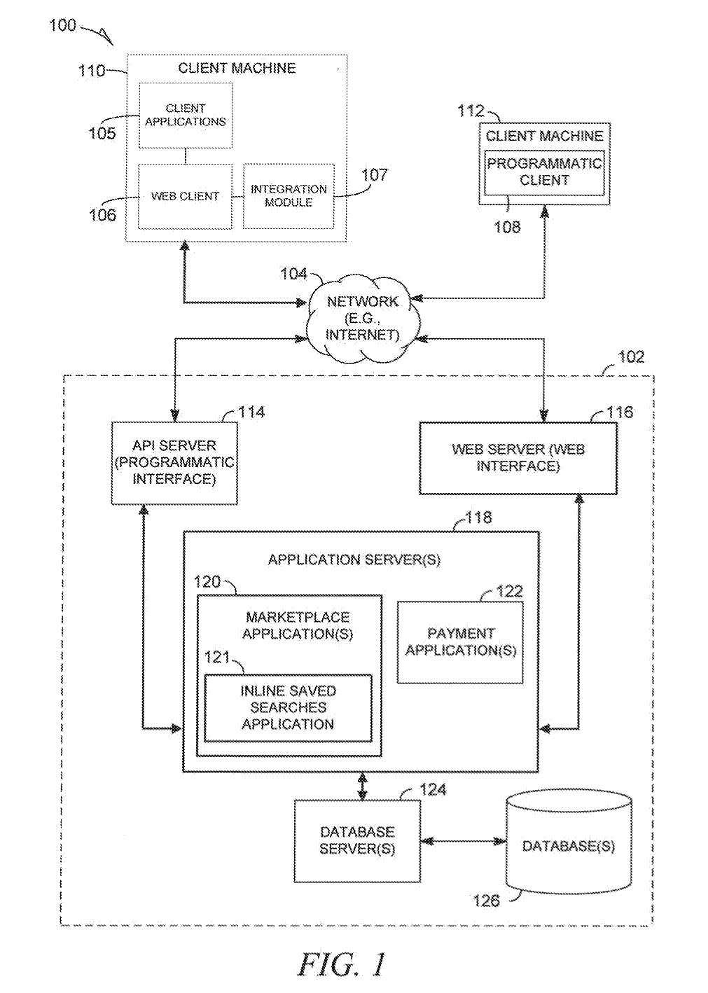

Embodiments of the present invention include approaches that enhance users' experience by permitting a user to save a search (e.g., by storing search parameters as associated with an identification string). A user may then, be able to execute, again, a search using the saved parameters and may also be provided with information regarding any new results that may appear in the results of a later-executed search. Example method and system to provide inline saved searches may be implemented in the context of a network environment 100 illustrated in FIG. 1, specifically as the inline saved searches application 121.

FIG. 1 is a network diagram depleting a client-server system 100, within which one example embodiment may be deployed. A networked system 102, in the example forms of a network-based marketplace or publication system, provides server-side functionality, via a network 104 (e.g., the Internet or Wide Area Network (WAN)) to one or more clients. FIG. 1 illustrates, for example, client applications 105 (e.g., mobile applications), an integration module 107, and a web client 106 (e.g., a mobile or desktop Web browser) operating on the client machine 110 (e.g., a mobile device), as well as a programmatic client 108 operating on the client machine 112.

An application Program Interface (API) server 114 and a web server 116 are coupled to, and provide programmatic and web interlaces respectively to, one or more application servers 118. The application servers 118 host one or more marketplace applications 120 and payment applications 122. The application servers 118 are, in turn, shown to be coupled to one or more databases servers 124 that facilitate access to one or more databases 126.

The marketplace applications 120 may provide a number of marketplace functions and services to users that access the networked system 102. Shown in FIG. 1 is an inline saved searches application 121 included as one of the marketplace applications 120. The inline saved searches application 121 maybe utilised beneficially to provide a user with Information about changes in the results of saved searches as described herein.

The payment applications 122 may provide a number of payment services and functions to users. The payment applications 122 may allow users to accumulate value (e.g., in a commercial currency, such as the U.S. dollar, or a proprietary currency, such as “points”) in accounts, and then later to redeem the accumulated value for products (e.g., goods or services) that are made available via the marketplace applications 120. While the marketplace and payment applications 120 and 122 are shown in FIG. 1 to both form part of the networked system 102, it will be appreciated that, in alternative embodiments, the payment applications 122 may form part of a payment service that is separate and distinct from the networked system 102.

Further, while the system 100 shown in FIG. 1 employs client-server architecture, the subject matter of the application is of course not limited to such an architecture, and could equally well find application in a distributed, or peer-to-peer, architecture system, for example. The various marketplace and payment applications 120 and 122 could also be implemented as standalone software programs, which do not necessarily have networking capabilities.

The web client 106 accesses the various marketplace and payment applications 120 and 122 via the web interface supported by the web server 116. Similarly, the programmatic client 108 accesses the various services and functions provided by the marketplace and payment applications 120 and 122 via the programmatic interface provided by the API server 114. The programmatic client 108 may, for example, be a seller application (e.g., the TurboLister application developed by eBay Inc., of San Jose, Calif.) to enable sellers to author and manage listings on the networked system 102 in an off-line manner, and to perform batch-mode communications between the programmatic client 108 and the networked system 102.

The integration module 107 on the client machine (e.g., a mobile phone) may submit requests to the marketplace applications 110, through the API server 114, for an up-to-date (e.g., current) publication related to goods and/or services being offered for sale via the networked system 102. A publication related to goods and/or services being offered tor sale may also be termed an item listing. Alternatively or additionally the client machine 110 may request one or more current publications from the client machine 112, via the network 104. In various example embodiments, the client machine 112 may provide a current publication to the client machine 110, after generating the current publication or retrieving such a publication from the networked system 102.

In some example embodiments, the integration module is embedded within one or more of the client applications 105 and may collect user parameters, receive targeted current publications based on the user parameters, and cause the display of one or more targeted current publications. A targeted current publication may be displayed among graphics associated with the application in which the integration module is embedded.

The applications 120, including the inline saved searches application 121, may be hosted on dedicated or shared server machines (not shown) that are communicatively coupled to enable communications between server machines. The applications themselves are communicatively coupled (e.g., via appropriate interlaces) to each other and to various data sources, so as to allow information to be passed between the applications or so as to allow the applications to share and access common data. The applications may furthermore access server one or more databases 126 via the database servers 128.

The networked system 102 may provide a number of publishing, lifting and price-setting mechanisms whereby a seller may list (or publish) information concerning) goods or services for sale, a buyer can express interest in or indicate a desire to purchase such goods or services, and a price can be set for a transaction pertaining to the goods or service.

In one example embodiments inline saved search provides on-click access to saving, editing and retrieval of saved searches. A notification of new item listings may also be built in. The aspects associated with a saved search can be shown in a drop-down fashion. When a user requests a search, the search results are time-stamped, so that a search performed at a later time may include a list of search results and also information with respect to which and how many items in the search results are new as compared with a previously-performed search.

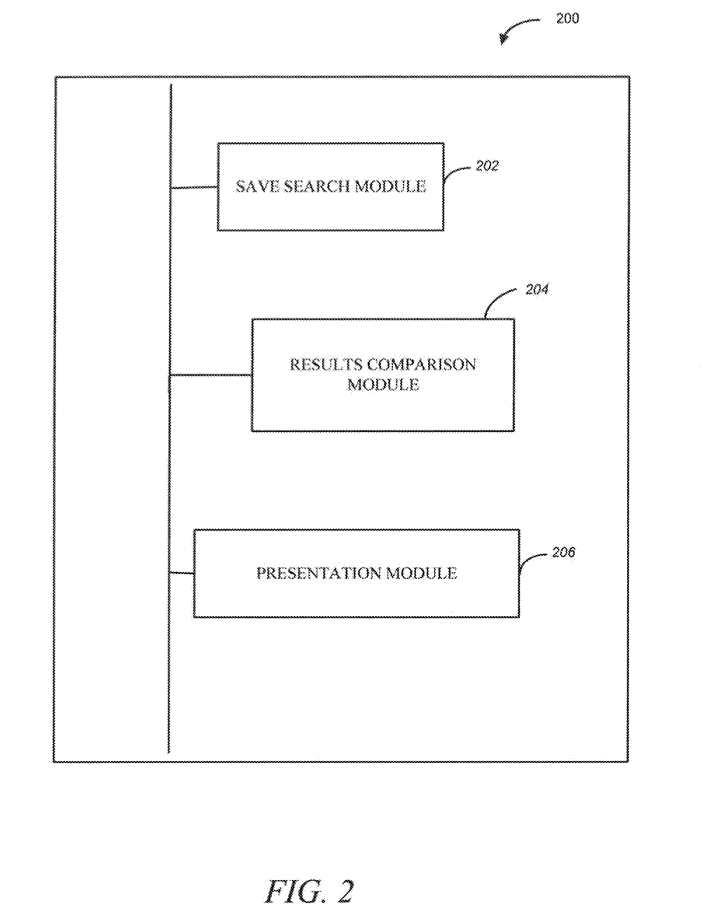

FIG. 2 is a block diagram of a system 200 to provide inline saved searches, in accordance with one example embodiment. As shown in FIG. 2, the system 200 includes a save search, module 202, a results comparison module 204, and a presentation module 206. The save search module 202 may be configured to execute a search based on the search request to produce first search results, save parameters of the first search, and execute one or more further search requests using the parameters of the first search request. The results comparison module 204 may be configured to identity results from the second search results that are not present in the first search results. In one embodiment, save search module 202 associates a time stamp with the first search results, such that the results comparison module 204 may utilize the time stamp to determine the presence of any results from the second search results that are not present in the first search results.

The presentation module 206 may be configured to present, on a display device, information reflecting a presence of results from the second search results that are not present in the first search results. For example, presentation module 206 may present only those results from the second search results that are not present in the first search results, as well as provide a visual identification of those results from the second search results that are not present in the first search results and/or provide information of how many of those results from the second search results are not present in the first search results.

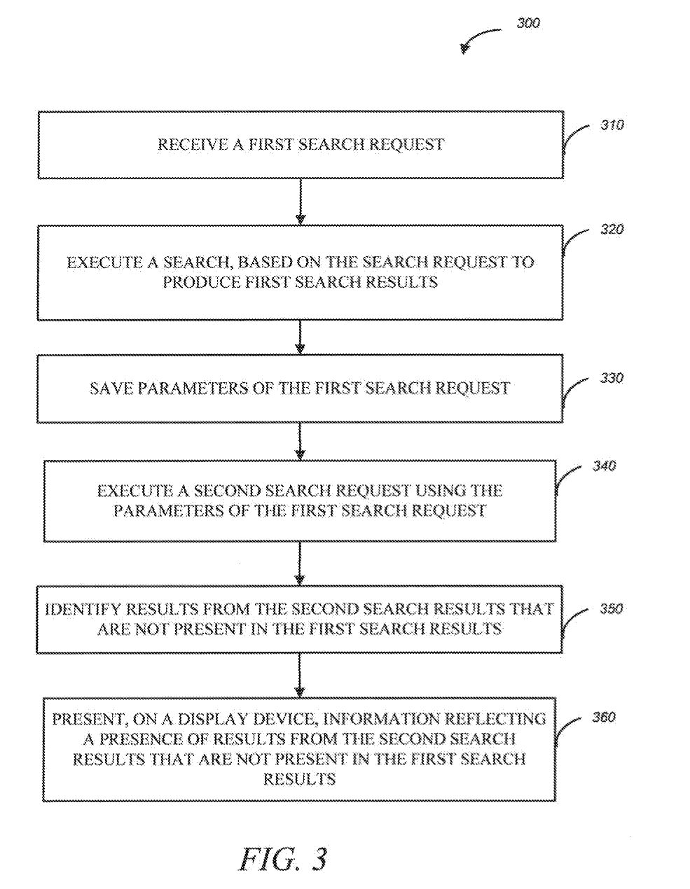

The save search module 202 may be configured to save the parameters of the first search request when a user activates a save search visual control. A save search visual control may be provided as part of a search box on the display device. In one embodiment, the save search visual control may be configured to trigger a drop down menu. Such drop-down menu may include an option to save the parameters of the first search request, as well permit a user to request that a notification is sent upon a new listing that satisfies criteria of the first search becomes available. The option to request a notification may further include a selection associated with how frequently a user is to be notified with respect to whether a new listing that satisfies criteria of the first search is available. An example method to provide inline saved searches can be described with reference to FIG. 3.

FIG. 3 is a flow chart of a method 300 to provide inline saved searches, according to one example embodiment. The method 300 may be performed by processing logic that may comprise hardware (e.g., dedicated logic, programmable logic, microcode, etc.), software (such as run on a general purpose computer system or a dedicated machine), or a combination of both. In one example embodiment, the processing logic resides at the server system 118 of FIG. 1 and, specifically, at the system 200 shown in FIG. 2.

The method 300 commences when, in response to a search request (operation 310), the save search module 202 of FIG. 2 executes a search based on the search request and the search request produces a set of search results that may be termed a first search results at operation 320. At operation 330, the save search module 202 saves parameters of the first search. As mentioned above, the parameters of the first search request may be saved when a user activates a save search visual control that may be provided as part of a search box on the display device. At operation 340, the save search module 302 executes a further search requests using the parameters of the previously saved search request. The results comparison module 204 of FIG. 2 identifies results from the second search results that are not present in the first search results at operation 350. As explained above, in one embodiment, the save search module 202 associates a time stamp with the first search results, such that the results comparison module 204 may utilise the time stamp to determine the presence of any results from the second search results that are not present hi the first search results. The presentation module 206 of FIG. 2 presents, on a display device, information reflecting a presence of results from the second search results that are not present in the first search results, at operation 360.

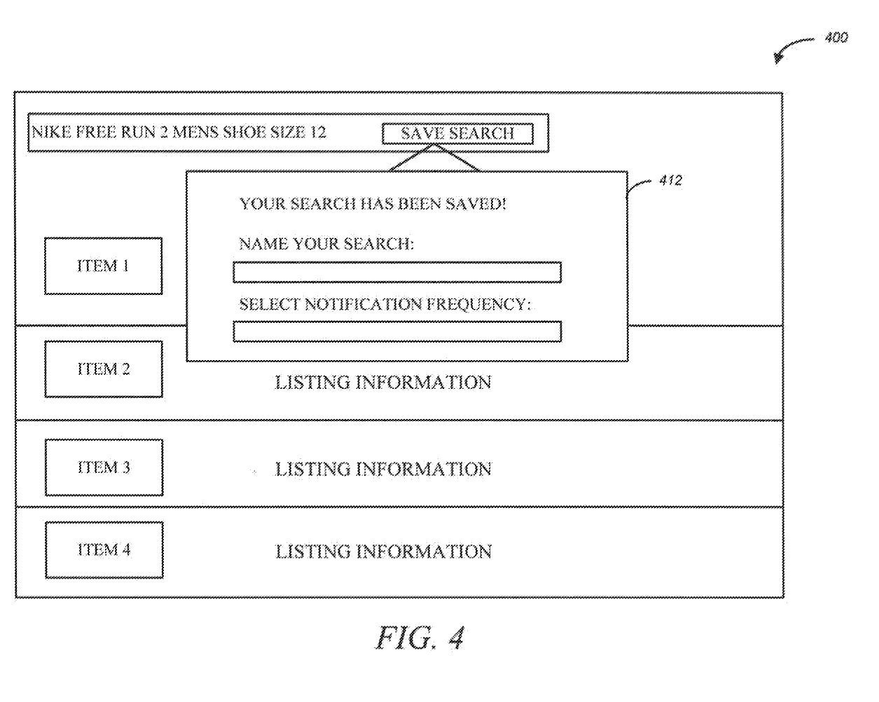

FIG. 4 shows a user Interface 400 including a hover window 412 that notifies a user that the requested search parameters have been saved and permits a user to request to receive a notification when new items that satisfy the search parameters become available. A user may also specify the desired frequency of the notifications.

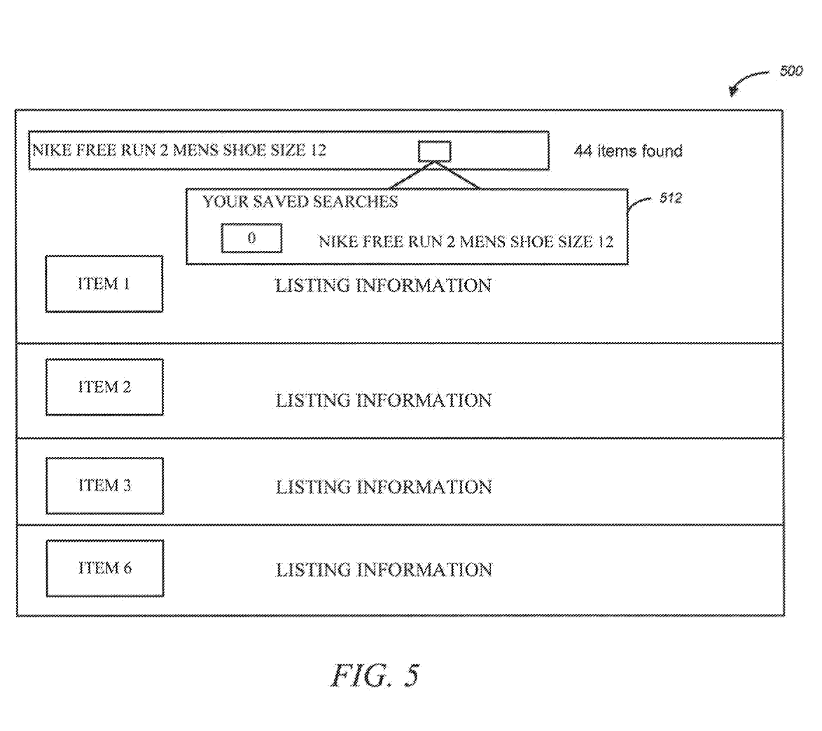

When a user performs a saved search, the system (e.g., the inline saved searches application 121 of FIG. 1) may present the user with information as to how many new items have been listed since the last search. FIG. 5 shows a user interface 400 including a hover window 512 that notifies a user that the saved search has been executed that that there are 0 (zero) new listings that satisfy the saved search parameters, as compared to the previously execution of the saved search. As mentioned above, in some embodiments, a user may be permitted to request that only newly-listed items are displayed when the saved search is executed.

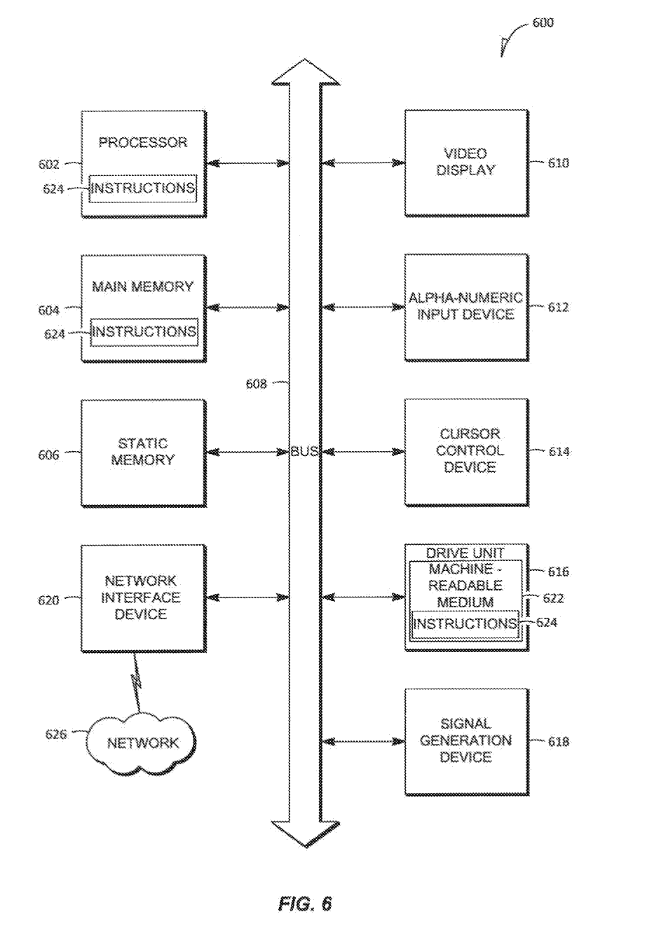

FIG. 6 is a diagrammatic representation of a machine in the example form, of a computer system 600 within which a set of instructions, for causing the machine to perform any one or more of the methodologies discussed herein, may be executed. In alternative embodiments, the machine operates as a stand-alone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 600 includes a processor 602 (e.g., a central processing unit (CPU), a graphics processing unit (GPU) or both), a main memory 604 and a static memory 606, which communicate with each other via a bus 606. The computer system 600 may further include a video display unit 610 (e.g., a liquid crystal display (LCD) or a cathode ray tube (CRT)). The computer system 600 also includes an alpha-numeric input device 612 (e.g., a keyboard), a user interface (UI) navigation device 614 (e.g., a cursor control device), a disk drive unit 616, a signal generation device 618 (e.g., a speaker) and a network interface device 620.

The disk drive unit 616 includes a machines-readable medium 622 on which is stored one or more sets of instructions and data, structures (e.g., software 624) embodying or milked by any one or more of the methodologies or functions described herein. The software 624 may also reside, completely or at least partially, within the main memory 604 and/or within the processor 602 during execution thereof by the computer system 600, with the main memory 604 and the processor 602 also constituting machine-readable media.

The software 624 may further be transmitted or received over a network 626 via the network interface device 620 utilizing any one of a number of well-known transfer protocols (e.g., Hyper Text Transfer Protocol (HTTP)),

While the machine-readable medium 622 is shown in an example

embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing and encoding a set of instructions for execution by the machine and that cause the machine to perform any one or more of the methodologies of embodiments of the present invention, or that is capable of storing and encoding data structures utilized by or associated with such a set of instructions. The term “machine-readable medium” shall accordingly be taken to include, but not be limited to, solid-state memories, optical and magnetic media. Such media may also include, without limitation, hard disks, floppy disks, flash memory cards, digital video disks, random access memory (EAMs), read only memory (ROMs), and the like.

The embodiments described herein may be implemented in an operating environment comprising software installed on a computer, in hardware, or in a combination of software and hardware. Such embodiments of the inventive subject matter may be referred to herein, individually or collectively, by the term “invention” merely for convenience and without intending to voluntarily limit the scope of this application to any single invention or inventive concept if more than one is, in fact, disclosed.

### MODULES, COMPONENTS AMD LOGIC

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hard ware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hard ware-implemented modules can provide information to and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS), For example, at least some of the operations may be performed by a group of computers (as examples of machines including processors), these operations being accessible via a network (e.g., the Internet) and via one or more appropriate interfaces (e.g., Application Program Interfaces (APIs).)

Thus, method and system to provide inline saved searches have been Described. Although embodiments have been described with reference to specific example embodiments, it will he evident that various modifications and changes may be made to these embodiments without departing from the broader spirit and scope of the inventive subject matter. Accordingly, the specification and drawings are to be regarded in an illustrative rather than a restrictive sense.

1. A system comprising:
at least one processor coupled to a memory;
a save search module to:
execute, using at least one processor, a search based on the search request to produce first search results,
save parameters of the first search requests using at least one processor, and
execute a second search request using the parameters of the first search, request, using at least one processor;
a results comparison module to identify, using at least one processor, results from the second search results that are not present in the first search results; and
a presentation module to present, on a display device, information reflecting a presence of results from the second search results that are not present in the first search results.

2. The system of claim 1, wherein the presentation module is to present only those results from the second search results that are not present in the first search results.

3. The system of claim 1, wherein the presentation module is to provide a visual identification of those results from the second search results that are not present in the first search results.

4. The system of claim 1, wherein the presentation module is to provide information of how many of those results from the second search results are not present in the first search results.

5. The system of claim 1, wherein:
the save search module is to associate a time stamp with the first search results; and
the results comparison module is to utilize the time stamp to determine presence of results from the second search results that are not present in the first search results.

6. The system of claim 1, wherein the save search module is to save the parameters of the first search request in response to an event associated with a save search visual control provided as part of a search box on the display device.

7. The system of claim 6, wherein the save search visual control is to trigger a drop down menu.

8. The system of claim 7, wherein the drop-down menu comprises an option to save the parameters of the first search request.

9. The system of claim 7, wherein the drop-down menu comprises an option to request a notification upon a new listing that satisfies criteria of the first search becomes available.

10. The system of claim 9, wherein the option to request a notification comprises a further selection associated with how frequently a user is to be notified with respect to whether a new listing that satisfies criteria of the first search is available.

11. A method comprising:
receiving a first search request;
executing,, using at least one processor, a search based on the search request to produce first search results;
saving parameters of the first search request;
executing a second search request using the parameters of the first search request;
identifying results from the second search results that are not present in the first search results; and
presenting, on a display device, information reflecting a presence of results from the second search results that are not present in the first search results.

12. The method of claim 11, wherein the presenting of the information reflecting a presence of results from the second search results that are not present in the first search results comprises presenting only those results from the second search results that are not present in the first search results.

13. The method of claim 11, wherein the presenting of the information reflecting a presence of results from the second search results that are not present in the first search results comprises providing a visual identification of those results from the second search results that are not present in the first search results.

14. The method of claim 11, wherein the presenting of the information reflecting a presence of results from the second search results that are nor present in the first search results comprises providing information of how many of those results from the second search results are not present in the first search results.

15. The method of claim 11, comprising:
associating a time stamp with the first search results; and
utilising the time stamp to determine presence of results from the second search results that are not present in the first search results.

16. The method of claim 11, wherein the saving of the parameters of the first search request is in response to an event associated with a save search visual control provided as part of a search box.

17. The method of claim 16, wherein the save search visual control is to trigger a drop down menu.

18. The method of claim 17, wherein the drop-down menu comprises an option to save the parameters of the first search request.

19. The method, of claim 17, wherein the drop-down menu comprises an option to request a notification upon a new listing that satisfies criteria of the first search becomes available.

20. A machine-readable non-transitory storage medium having instruction data to cause a machine to:
execute a search, based on the search request, to produce first search results;
save parameters of the first search request;
execute a second search request using the parameters of the first search request;
identify results from the second search results that are not present In the first search results; and
present, on a display device, information reflecting a presence of results from the second search results that are not present in the first search results.
